(19) United States
(12) Patent Application Publication
(10) Pub. No.: US 2024/0308857 A1
(43) Pub. Date: Sep. 19, 2024

(54) APPARATUS AND METHOD FOR PRODUCING 3N OR HIGHER PURITY SILICON BY PURIFYING 2N PURITY SILICON

(71) Applicant: HPQ Silicium Inc., Montreal (CA)

(72) Inventors: Jed KRAIEM, LYON (FR); Oleksiy NICHIPORUK, MIONS (FR); Julien DEGOULANGE, SAINT GENIS LAVAL (FR)

(21) Appl. No.: 18/606,401

(22) Filed: Mar. 15, 2024

(30) Foreign Application Priority Data
Mar. 15, 2023 (FR) FR2302409

(51) Int. Cl. C01B 33/037; C01B 33/021

(52) U.S. Cl. CPC C01B 33/037; C01B 33/021

(57) ABSTRACT

The present invention relates to an apparatus for producing 3N purity silicon by purification of 2N purity silicon, the purification including the steps of air injection (E1), filtering (E2) and solidification (E3) to obtain 3N purity silicon in the solid state.

### FIELD OF THE INVENTION

The present invention relates to the general technical field of purifying silicon generated from quartz to obtain 3N or higher purity silicon (4N, 5N, 6N, etc.).

In particular, the invention relates to methods for treating silicon produced by carbon reduction of quartz in an electric arc furnace.

### BACKGROUND OF THE INVENTION

### 1. Generalities

The production of metal silicon is generally based on the carbothermal reduction of quartz at high temperature and atmospheric pressure. This carbothermal reduction of quartz can be achieved by chemically reducing quartz in the presence of carbon-based reducing agents in an electric arc furnace where a high temperature arc heats the reagents (quartz and reducing agents).

This allows to produce a silicon called “Metallurgical Grade” Silicon (or “MG-Si”) having a purity of 99% (or “2N” for the total number of “9”).

Metallurgical grade silicon can be used:
as an alloying element—for example in the aluminum and steel industry—or
as a precursor—for example in the photovoltaic industry (solar panels), for silicones and for energy storage.

Technological developments in the fields of photovoltaics and energy storage have led metallurgical grade silicon to become a strategic material. Therefore, sourcing high purity metallurgical grade silicon at a reasonable cost has become a necessity.

Moreover, more and more technologies need to have silicon with purity 99.9% (3N) and 99.99% (4N), or even 99.999% (5N).

However, one of the disadvantages of conventional metallurgical silicon production devices and methods is the high content of impurities contained in the metallurgical silicon produced.

### 2. Existing Purification Solutions for Conventional Production Methods

To limit the high content of impurities contained in the silicon produced using conventional devices and methods, there are different solutions.

A first solution consists in using a raw material (quartz) with high purity. However, this solution increases the cost of silicon production.

A second solution consists in implementing acid treatments after the production of 2N purity silicon, in order to obtain 3N or higher purity silicon. Such acid treatments allow to dissolve the impurities present at the grain boundaries of 2N purity silicon obtained from conventional metallurgical silicon production devices and methods. However, the disadvantages of such a solution relate to its high cost, as well as its unfavorable environmental footprint, because of the use of toxic acid(s). Indeed, the implementation of an acid-based post-treatment requires specific adapted installations. Moreover, the treatment of the gases and effluents produced—when subjecting 2N purity silicon to an acid attack—is expensive due to environmental rules.

A third solution consists in carrying out, after the production of 2N purity silicon:
a directional solidification step to obtain a silicon ingot, and
a trimming step consisting in removing the upper part of the ingot and retaining only the lower part of greater purity.

The directional solidification step allows, by segregation, to concentrate the impurities in the upper part of the silicon ingot resulting from directional solidification. The trimming step allows this upper part to be removed to retain only the lower part of 3N or higher purity. However, a disadvantage of such a solution is that the directional solidification step is very slow.

### 3. Method According to U.S. Pat. No. 11,267,714 and Purpose of the Present Invention

Document U.S. Pat. No. 11,267,714 proposes another solution consisting in implementing the carbothermal reduction of quartz at high temperature under vacuum.

With reference to FIG. 1, the apparatus according to U.S. Pat. No. 11,267,714 comprises an electric arc furnace FA and a sealed, closed enclosure E containing the arc furnace FA. This arrangement (sealed enclosure E containing the arc furnace FA) allows to control the pressure at which the carbothermal reduction of quartz is implemented.

Carrying out the carbothermal reduction of quartz under vacuum allows to promote the evaporation of impurities present in the reagents (quartz and reducing agents) as well as in the newly produced liquid metallurgical grade silicon.

A purpose of the present invention is to propose a method for purifying silicon produced according to the technique described in U.S. Pat. No. 11,267,714.

In particular, a purpose of the present invention is to propose one (or more) improvement(s) to the apparatus according to U.S. Pat. No. 11,267,714 to facilitate its use on an industrial scale in the context of the production of 3N or higher purity silicon.

### BRIEF DESCRIPTION OF THE INVENTION

For this purpose, the invention proposes an apparatus for producing 3N or higher purity silicon, the apparatus comprising a device for producing 2N purity silicon including:
a sealed enclosure connected to at least one suction pump to generate a depression inside the enclosure when the suction pump is activated,
an electric arc furnace housed inside the sealed enclosure, the arc furnace including a tank for containing a mixture of raw materials, and a set of electrodes configured to heat said mixture in order to produce 2N purity silicon,
   remarkable in that the apparatus further comprises a purification device for obtaining 3N purity silicon, said purification device including a casting ladle and an electromagnetic stirrer downstream of the casting ladle:
the casting ladle including:
   a reservoir adapted to contain a bath of silicon in the liquid state, said bath being composed of 2N purity silicon obtained from the production device,
   an injection nozzle for injecting a gas into the silicon bath in the liquid state, the injection of the gas allowing to obtain a refined liquid silicon having a purity greater than the 2N purity silicon resulting from the production device,
   a filter disposed upstream of the electromagnetic stirrer for filtering the refined liquid silicon, the filtering allowing to obtain a filtered liquid silicon having a purity greater than the refined liquid silicon, and
the electromagnetic stirrer being configured to receive the liquid filtered silicon and to solidify it at a solidification speed greater than or equal to 5 cm/h, preferably greater than or equal to 10 cm/h, the solidification allowing to obtain a purified solid silicon bell forming the 3N or higher purity silicon.

Preferred but non-limiting aspects of the apparatus according to the invention are the following:
the electromagnetic stirrer may comprise a mechanical mixer and/or an inductive stirrer to induce a movement of the liquid filtered silicon at a speed greater than or equal to 1 ms;
the filter may comprise pores whose dimensions are comprised between 75 micrometers and 3 millimeters, preferably between 100 micrometers and 2.5 millimeters, and even more preferably between 500 micrometers and 2 millimeters;
the casting ladle may further include a heating system configured to maintain the silicon bath in the liquid state contained in the reservoir at a temperature greater than or equal to 1600° C., preferably greater than or equal to 1700° C.;
the nozzle can be supplied with gas by a power source configured to inject said gas at a flow rate comprised between 2 and 10 m³/h;
the electromagnetic stirrer may be devoid of thermal insulator to induce cooling of the purified solid silicon block at a speed comprised between 150° C./h and 500° C./h, preferably between 200° C./h and 300° C./h;
the 2N purity silicon production device may also comprise a control unit configured to:
   during a pretreatment step:
      reduce the pressure inside the enclosed space to a value below atmospheric pressure,
   implement resistive heating of the mixture of raw materials, o during a carbon reduction step:
      increase the pressure inside the enclosed space to a value substantially equal to atmospheric pressure,
      implement electric arc heating of the mixture of raw materials,
      when the temperature of the mixture is greater than 2000° C.:
         maintain the pressure inside the enclosed space at a value substantially equal to atmospheric pressure,
         maintain electric arc heating of the mixture of raw materials,
   during a post-treatment step:
      reduce the pressure inside the enclosed space to a value below atmospheric pressure.

The invention also relates to a method for producing 3N or higher purity silicon, the method comprising:
a phase of producing 2N purity silicon from a production device including a sealed enclosure connected to a suction pump, and an electric arc furnace housed inside the sealed enclosure, the production phase including the following steps:
   loading an electric arc furnace tank with a mixture of raw materials,
   generating a depression inside the enclosure by activating the suction pump,
   heating the mixture using a set of arc furnace electrodes so as to produce 2N purity silicon,
      remarkable in that the method further comprises a purification phase for obtaining 3N purity silicon from a purification device including a casting ladle and an electromagnetic stirrer downstream of the casting ladle, said purification phase including the following steps:
of injecting, using an injection nozzle of the casting ladle, a gas into a silicon bath in the liquid state composed of 2N purity silicon obtained from the production device, said bath being contained in a reservoir of the casting ladle, the injection of the gas allowing to obtain a refined liquid silicon having a purity greater than the 2N purity silicon resulting from the production device,
of filtering, using a filter disposed upstream of the electromagnetic stirrer, refined liquid silicon to obtain a filtered liquid silicon having a purity higher than the refined liquid silicon, and
of solidifying, using the electromagnetic stirrer, the liquid filtered silicon at a solidification speed greater than or equal to 5 cm/h, preferably greater than or equal to 10 cm/h.

Preferred but non-limiting aspects of the method according to the invention are the following:
the solidification step may comprise a sub-step consisting in stirring the liquid filtered silicon at a speed greater than or equal to 1 ms;
the filtering step may consist in circulating the refined liquid silicon through a filter having pores whose dimensions are comprised between 75 micrometers and 3 millimeters, preferably between 100 micrometers and 2.5 millimeters, and even more preferably between 500 micrometers and 2 millimeters;
during the injection step, the gas can be injected into the liquid silicon bath at a flow rate comprised between 2 and 10 m³/h;
the phase of producing 2N purity silicon may comprise the following steps:
   a pretreatment step including the sub-steps consisting in:
   reducing the pressure inside the enclosure to a value lower than atmospheric pressure,
   implementing resistive heating of the mixture of raw materials,
      a carbon reduction step including the sub-steps consisting in:
      increasing the pressure inside the enclosed space to a value substantially equal to atmospheric pressure,
      implementing electric arc heating of the mixture of raw materials,
      then when the temperature of the mixture is greater than 1500° C.:
         maintaining the pressure inside the enclosed space at a value substantially equal to atmospheric pressure,
         maintaining electric arc heating of the mixture of raw materials,
   a post-treatment step including a sub-step consisting in reducing the pressure inside the enclosed space.

### BRIEF DESCRIPTION OF THE DRAWINGS

Other advantages and features of the silicon production method according to the invention will become clearer from the following description of several variant embodiments, given by way of non-limiting examples, from the appended drawings in which:
FIG. 1 is a schematic representation of a 2N purity silicon production device of the prior art,
FIG. 2 is a schematic diagram of an apparatus for producing 3N or higher purity silicon including a device for producing 2N purity silicon and a purification device for obtaining 3N purity silicon,
FIG. 3 is a schematic representation of different phases of a silicon production method from the production device illustrated in FIG. 2,
FIG. 4 is a schematic representation illustrating a separation front between a liquid phase and a solid phase,
FIG. 5 is a schematic representation of different phases of a method for producing 3N purity silicon.

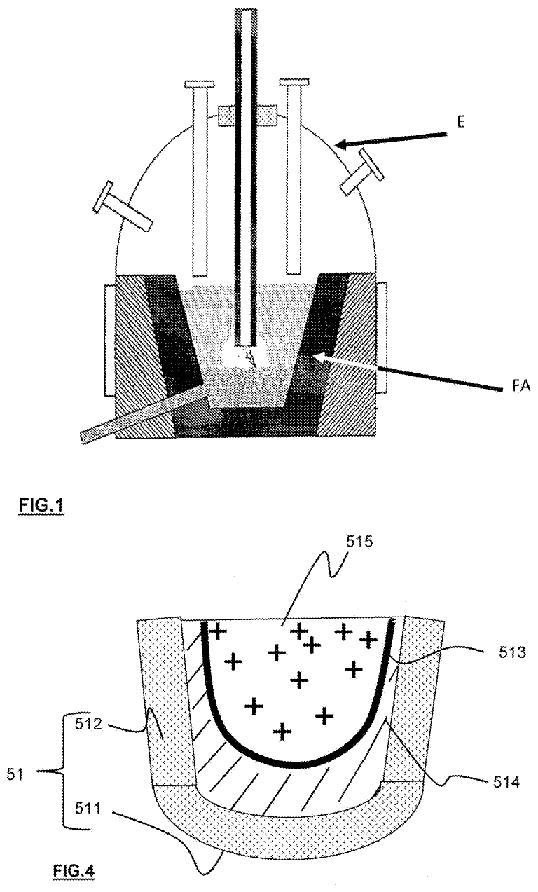

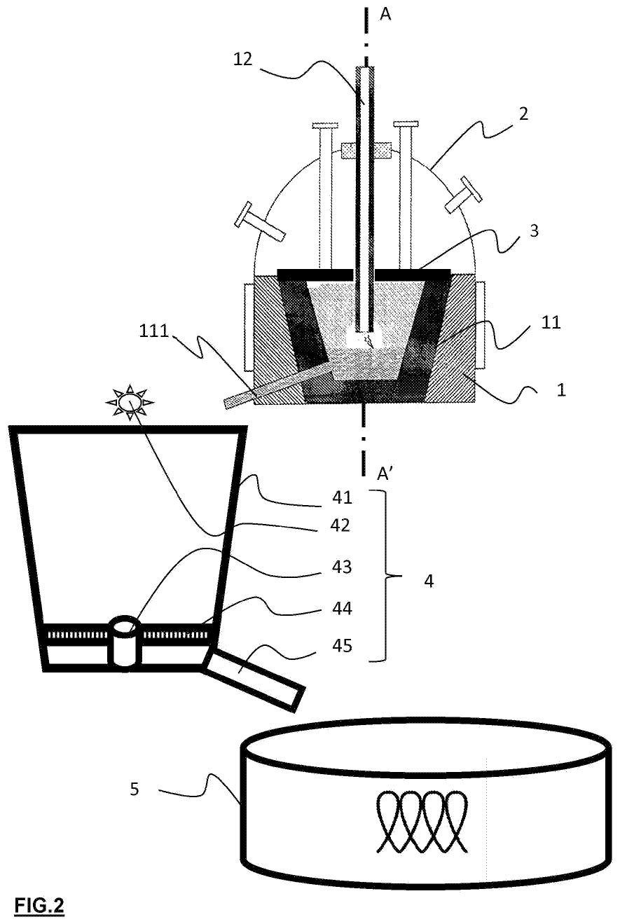

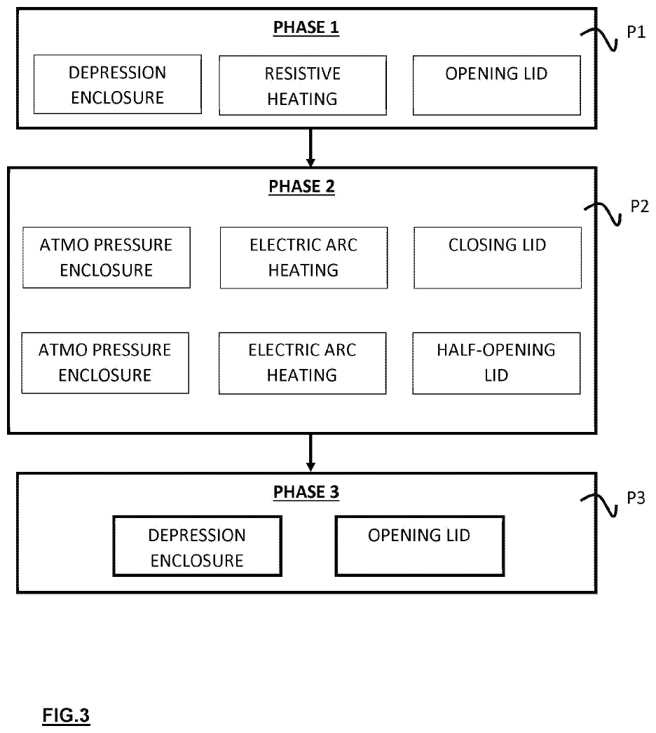

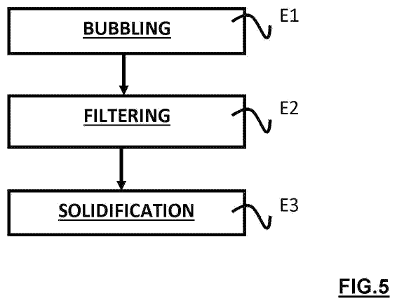

### DETAILED DESCRIPTION OF THE INVENTION

Different exemplary embodiments of the invention will now be described with reference to the figures. In these different figures, the equivalent elements are designated by the same numerical reference.

### 1. Generalities

With reference to FIG. 2, the apparatus according to the invention comprises:
a device for producing 2N purity silicon, and
a device for purifying 2N purity silicon (produced by the production device) to obtain 3N or higher purity silicon.

### 2. Silicon Production Device

The silicon production device comprises:
an electric arc furnace 1,
a sealed enclosure 2, and optionally
a lid 3 adapted to cover a tank 11 of the electric arc furnace 1, the arc furnace 1 and the lid 3 being housed in the enclosure 2.

### 2.1. Arc Furnace

The arc furnace 1 allows:
on the one hand to contain the reagents—namely quartz and reducing agents—for the production of 2N purity silicon, and
on the other hand, to heat said reagents to a high temperature to induce the carbothermal reduction reaction of the quartz.

The arc furnace 1 in particular comprises the tank 11 and electrodes 12.

Tank 11 is intended to contain the reagents, but also the liquid silicon resulting from the carbothermal reduction reaction of quartz. The tank includes a bottom, one (or more) side wall(s), and an upper opening (covered by the lid 3 in FIG. 2) opposite the bottom.

A longitudinal central axis of the device which is vertical when the device is placed on a flat horizontal surface is denoted A-A′. The (or the assembly composed of) side wall(s) of the arc furnace 1 is substantially centered on the axis A-A′.

In the following, the description is detailed by considering that the terms “upper” and “top” correspond to a direction generally parallel to the axis A-A′ and going from the bottom towards the opening of the tank 1, while the terms “lower” and “down” correspond to opposite directions.

The tank 11 also includes a casting channel (or several casting channels) 111 for evacuating the metallurgical grade silicon produced (in the liquid state) to the purification device. An obturating system—such as a valve or a nozzle or a plug made of carbon material—can be provided for closing the casting channel(s) 111 during the carbothermal reduction reaction of the quartz. At the time of casting, the tank 11, which can be mounted for example on a tilting cradle, is inclined towards the casting ladle so as to gradually send the metallurgical grade silicon in the liquid state through the casting channel(s). The casting channel(s) 111 then being open, the liquid metallurgical grade silicon can then flow out of the tank and be collected in the casting ladle. Of course, other configurations are possible to allow the extraction of metallurgical grade silicon.

For example, the bottom of the container may have a non-zero slope in the direction of the casting channel(s) so as to send the metallurgical grade silicon towards the casting ladle when the obturating system is removed from the channel (method known as “tapping”).

The electrodes 12 can be power supplied either from a direct current source or from an alternating current source. These electrodes 12 allow the formation of an electric arc allowing the heating of the reagents (quartz and reducing agent) to induce the production of 2N purity silicon.

Preferably, the electrodes 12 are placed in the axis of the arc furnace 1 so as to be stressed in a relatively symmetrical manner. More precisely, each electrode 12 may consist of a cylindrical bar of graphite extending vertically.

### 2.2. Enclosure

The sealed enclosure 2 allows to define a closed space in which it is possible to generate a depression, that is to say a space in which it is possible to reduce the pressure to a value lower than atmospheric pressure.

Such an enclosure 2 can have different shapes and be made from different materials to ensure this function. Thus, in the context of the present invention, the term “tight enclosure” means a casing composed of at least one wall—for example made of steel—on either side of which there is a pressure difference. Thus, the sealed enclosure allows to delimit two areas (that is to say an internal area and an external area) between which there is a pressure difference.

The sealed enclosure 2 comprises one (or more) through orifice(s), possibly for the passage:
of one (or more) gas injection channel(s) into the enclosure 2, each channel being able to be connected to a gas supply source (such as argon),
of one (or more) gas suction channel(s) contained in the enclosure 2, each channel being able to be connected to a suction pump to allow the generation of a depression inside the enclosure 2,
of electrodes 12,
of one (or more) pipe(s) for supplying the arc furnace 1 with reagents R (quartz, reducing agents, etc.).
of electrical connection means (such as an electrically conductive cable, for example for the electrical connection of a sensor contained in the enclosure, etc.),
of the casting channel(s) 111, etc.

### 2.3. Lid

The lid 3 is configured to cover the upper opening of the tank 11.

The lid 3 allows to contain the gases, and in particular the gas compound of silicon oxide (SiO)—formed during the carbon reduction reaction of quartz inside the tank 11 of the arc furnace 1. This allows to limit the risks of fouling of the enclosure 2, particularly at its partitions and the suction channel(s). Moreover, the lid 3 allows to maintain the arc furnace 1 at a temperature (and more precisely at a temperature gradient) favoring the consumption of the reagents. This increases the reaction rate of the device, in particular with respect to the silicon production device described in U.S. Pat. No. 11,267,714.

The lid 3 may have a frustoconical shape, a dome shape, or a disc shape. The lid 3 can be made of any type of refractory thermal insulation material known to the person skilled in the art, such as graphite.

Advantageously, the lid 3 is movable. More precisely, the lid 3 can be moved between:
a closed position in which the lid 3 completely covers the upper opening of the tank 11 (the edges of the lid 3 being in contact with the edges of the upper opening in the closed position), and
an open position in which the lid 3 does not cover (or partially covers) the upper opening of the tank 11.

For this purpose, one (or more) support shaft(s) (not shown) of the lid 3 can be connected to one (or more) motor(s).

The fact that the lid 3 is movable allows access to the inside of the tank of the arc furnace 1, for example:
for maintenance operations on the arc furnace 1, and/or
to load/reload the inside of the tank 11 with reagents necessary for the carbon reduction reaction, and/or
to promote the evacuation of certain gases produced during the carbon reduction reaction, etc.

Advantageously, the lid 3 may comprise one (or more) through aperture(s) capable of being blocked by one (or more) movable obturating component(s). This (or these) through aperture(s) form(s) gas exhaust pipe(s) confined in a region defined between the tank 11 and the lid 3 (in the closed position).

### 2.4. Operating Principle

With reference to FIG. 3, the operating principle of the device for producing 2N purity silicon is as follows.

It is assumed that a mixture of raw materials containing, for example, quartz, and a reducing agent, typically carbon, has been previously positioned in the tank 11.

### 2.4.1. Pretreatment Phase

A pretreatment phase P1 allowing the initiation of the carbon reduction reaction as well as the removal of impurities from the mixture of raw materials is implemented. This pretreatment phase comprises the steps:
of generating a depression in the sealed enclosure 2,
of resistively heating (thanks to the energy transferred by the electrodes 12) the mixture of raw materials contained in the tank 11, and
of opening the lid 3.

During this pretreatment phase P1, certain impurities are volatilized, those having a high vapor pressure. Generating a depression in the enclosure, and opening the lid while heating the raw materials allows impurities to escape out of the enclosure (said impurities being sucked up by the suction pump).

### 2.4.2. Carbon Reduction Phase

Once this pretreatment phase P1 is completed (when the temperature in the enclosure reaches 1000°° C. to 1500° C.), a carbon reduction phase P2 is implemented. This carbon reduction phase P2 comprises the steps:
of returning to atmospheric pressure in the sealed enclosure 2,
of closing the lid 3 and heating by electric arc the mixture contained in the arc furnace 1 up to a carbon reduction temperature, and of half-opening the lid 3 and maintaining the electric arc heating of the mixture.

Closing the lid 3 and generating an electric arc in the arc furnace allows to quickly increase the temperature of the mixture to 1500 to 2000° C.

Once the temperature has been reached, the fact of half-opening the lid 3 while maintaining electric arc heating allows heat dissipation of the upper part of the reaction medium: a temperature gradient is then created in the reaction medium (high temperature at the bottom of the tank 11 and lower at the upper opening of the tank 11). The fact of forming a temperature gradient in the tank 11 of the arc furnace allows the formation of the different reaction intermediates in the different temperature areas as well as the gas exchanges between them for an efficient carbon reduction reaction.

### 2.4.3. Post-Treatment Phase

At the end of the carbon reduction reaction P2, when all the raw materials have reacted and liquid silicon is formed in the tank 2, a post-treatment phase P3 is initiated. The lid 3 is completely raised. The depression of the enclosure 2 is again carried out to allow the elimination of impurities present in the liquid silicon and which have a high vapor pressure such as phosphorus, and resistive type heating is again implemented.

At the end of the post-treatment phase P3, the tank 11 contains 2N purity silicon in the liquid state. The casting channel(s) 111 is (are) open to evacuate the liquid 2N purity silicon to the purification device.

### 3. Purification Device

The purification device comprises:
a casting ladle 4 intended to receive the 2N purity silicon obtained from the production device, and
an electromagnetic stirrer 5 downstream of the casting ladle 4, the electromagnetic stirrer 5 being intended to receive the silicon coming from the casting ladle 4.
   3.1. Casting ladle

The casting ladle 4 allows:
on the one hand to maintain the silicon it contains in the liquid state, and
on the other hand to filter, thanks to a filter, (solid or liquid) residues contained in the 2N silicon resulting from the production device.

The casting ladle 4 comprises:
a reservoir 41 delimited by a refractory lining and intended to receive liquid 2N purity silicon obtained from the production device,
optionally, a heating system 42 associated with the reservoir 41 to maintain the silicon contained in the reservoir 41 in the liquid state,
a gas injection nozzle 43 opening into a lower part of the reservoir 41,
a filter 44 disposed in the reservoir 41, and
an outlet channel 45 for transferring the silicon contained in the reservoir 41 to the electromagnetic stirrer 5.

### 3.1.1. Reservoir

The reservoir 41 is of a type known to the person skilled in the art. It comprises a base, one (or more) side partition(s) and a filling orifice delimited by the edge(s) of the side partition(s) opposite the base.

In particular, the reservoir 41 is composed of a carcass in which a lining of refractory material is disposed. A cavity intended to receive the 2N purity silicon obtained from the production device is formed inside this lining.

### 3.1.2. Heating System

The heating system 42 can be of the resistive type or of the inductive type or a gas burner.

In the embodiment illustrated in FIG. 2, the heating system 42 comprises one (or more) graphite resistor(s) disposed in an upper part of the container 41.

In certain variant embodiments, the heating system 42 may also comprise one (or more) graphite resistance(s) disposed at the side partition(s) of the container 41. This allows better control of the temperature inside the container 41 over its entire height.

The heating system 42 may also comprise one (or more) graphite resistor(s) disposed in a lower part of the container 41, in particular under the base of the container 41.

Advantageously, the heating system is configured to maintain the liquid silicon contained in the reservoir at a temperature greater than 1600° C., and preferably greater than or equal to 1700° C.

Of course, the casting ladle can also be without a heating system to limit production costs.

### 3.1.3. Injection Nozzle

The injection nozzle 42 may consist of a graphite nozzle extending towards the inside of the reservoir 41 from its base.

The injection nozzle 42 allows to introduce gas—for example air or an air/oxygen mixture (to limit production costs) or an inert gas—into the liquid silicon contained in the reservoir 41 in order to oxidize impurities typically Aluminum and Calcium. Advantageously, the flow rate and speed of the gas introduced into the liquid silicon are respectively comprised between 2 and 10 Nm³/h, and 0.1 and 1 m/s. Advantageously, the reaction of the Oxygen in the gas with the Silicon is exothermic therefore it allows to heat the Silicon and prevent it from cooling too quickly which would induce solidification.

The introduction of the gas allows to eliminate certain impurities—calcium (Ca) and aluminum (AI)—contained in the molten silicon (reduction by a factor of two or three of the initial concentrations of Al and Ca contained in the molten silicon) by forming a slag on the surface of the molten silicon. Indeed, the oxygen reacts mainly with the aluminum and calcium contained in the molten silicon, which allows to eliminate a significant portion of these impurities.

In particular, the treatment by injection of air (or by injection of an inert gas) allows to obtain a mixture composed of two phases:
a refined silicon on the one hand,
a slag containing calcium and aluminum on the other hand, the slag extending to the surface of the refined silicon.

The slag can then be separated from the refined liquid silicon by any technique known to the person skilled in the art, for example by decantation or by means of tools such as a plane.

The implementation of stirring by gas injection allows to obtain refined silicon in the liquid state in which:
the aluminum concentration of the refined silicon is less than 0.2% ([Al]<0.2%), and
the calcium concentration of refined silicon is less than 0.02% ([Ca]<0.02%).

### 3.1.4. Filter

The filter 44 allows to retain impurities contained in the refined silicon to obtain a filtered liquid silicon intended to be transferred into the electromagnetic stirrer 5. For this purpose, the filter 44 can be housed in the reservoir 41, between the filling orifice and the outlet channel 45 extending at the base of the container 41. Thus the filtering of the impurities is carried out during the flow of the liquid silicon towards the outlet channel 44.

These impurities can be solid (unreacted raw materials, by-products generated during the carbon reduction reaction, etc.), or liquids with high viscosity (slag residues contained in liquid refined silicon, etc.).

The filter can be made of ceramic (preferably silicon carbide SiC) and consist of a body—such as a plate—including pores. Advantageously:
the thickness of the body can be comprised between 1 and 15 centimeters, preferably between 2 and 10 centimeters and even more preferably between 4 and 8 centimeters,
the median diameter of the pores can be comprised between 75 micrometers and 3 millimeters, preferably between 100 micrometers and 2.5 millimeters, and even more preferably between 500 micrometers and 2 millimeters.

These dimensions of the filter 44 are defined to guarantee effective separation of impurities while ensuring sufficiently rapid filtering of the refined silicon to avoid any risk of solidification of the silicon during this filtering.

### 3.1.5. Outlet Channel

The outlet channel 45 allows to evacuate the filtered liquid silicon outside the casting ladle 4 with a view to its transfer into the electromagnetic stirrer 5.

In certain alternative embodiments, the filtered liquid silicon pours from the outlet channel 45 into an intermediate receptacle—such as an intermediate casting ladle—prior to its introduction into the electromagnetic stirrer 5. In other alternative embodiments, the filtered liquid silicon is solidified quickly in an ingot mold to purify it, it will therefore be necessary to remelt it in an induction furnace before transferring it to the electromagnetic stirrer.

### 3.2. Electromagnetic Stirrer

The electromagnetic stirrer 5 allows:
on the one hand to concentrate impurities in the liquid phase of silicon by segregation, and
on the other hand to produce a 3N or higher purity silicon bell.

The electromagnetic stirrer 5 comprises:
a crucible 51 including a sole 511 and one (or more) side panel(s) 512 whose upper edge(s) opposite the sole 511 define(s) an inlet mouth:
   the crucible can be made of graphite to allow its reuse,
   the angle between the sole and the side panel(s) may be greater than or equal to 105° to facilitate the unmolding of the solidified silicon bell produced,
one (or more) inductor winding(s) (not shown) intended to stir, by induction, the silicon load contained in the crucible 51.

As indicated previously, the electromagnetic stirrer 5 allows to purify the filtered silicon coming from the casting ladle 4.

To purify the silicon, a solidification step under strong stirring is implemented in the electromagnetic stirrer 5. With reference to FIG. 4, this solidification takes place from the sole 511 of the crucible 51 and from the side walls of the crucible towards the mouth according to a rising solidification front (solid/liquid interface) 513. This solidification front 513 is strongly concave, the solidification of the silicon taking place both by the sole 511 and by the side panel(s) 512 of the crucible 51.

Solidification allows to obtain a purified solid silicon bell 514, and a liquid residue of impure silicon 515 in which the majority of the impurities are accumulated.

This accumulation of impurities in the liquid residue of impure silicon is obtained by segregation. Segregation is a physical phenomenon occurring during the solidification of a material. During the solidification of the material, the majority of impurities (especially metals) are released into the liquid phase.

Indeed the distribution of impurities follows the Scheil's law:

$${C}_{S} = {{kC}_{o} ( 1 - {f}_{S} )}^{k - 1} .$$

With k=Cₛ/Cₗ the segregation coefficient specific to the impurity in Silicon. The specific segregation coefficient is known to the person skilled in the art and will not be described in more detail below.

Thus, during the solidification of the silicon, the impurities preferentially remain in the liquid phase 515. This allows to obtain a solid 3N or higher purity silicon bell 514. The more the solid fraction 514 increases, the greater the concentration of impurities in the liquid phase 515.

Advantageously, the segregation phenomenon can be improved by effective stirring of the silicon bath in the liquid state. Stirring the liquid silicon bath allows to renew the liquid boundary layer at the solid/liquid interface, in order to promote the rejection of impurities in the liquid silicon phase.

Preferably, this stirring is obtained using an inductive stirrer allowing the application of an electromagnetic field—alternating or rotating or sliding—to the bath of liquid silicon. Advantageously, the inductive stirrer can be power supplied by an alternating current having a frequency comprised between 1 and 100 Hz, preferably of the order of 10 Hz for a crucible of 1 meter in diameter. Such a power frequency indeed allows:
to maximize stirring (speed of the liquid silicon bath >1 m/second) thanks to significant penetration of the electromagnetic field inside the crucible 51, and
to minimize the heat transferred to the liquid silicon bath in order to promote rapid solidification of the silicon bell (solidification speed greater than or equal to 5 cm/h, preferably greater than or equal to 10 cm/h).

Alternatively, this stirring can be obtained using a mechanical mixer such as a graphite propeller immersed in the liquid silicon bath and rotated by a motor shaft.

The electromagnetic stirrer allows to obtain a solid 3N or higher purity silicon bell 514 and a liquid residue of impure silicon 515 in which the majority of the impurities are accumulated.

The electromagnetic stirrer may comprise a cooling system (not shown) composed for example of one (or more) heat exchanger(s) in which a heat transfer fluid circulates. The integration of a cooling system allows to control the cooling rate of the solid 3N or higher purity silicon bell down to ambient temperature. The electromagnetic stirrer can also be without a specific cooling system.

### 4. Operating Principle

The operating principle of the purification device will now be described with reference to FIG. 4 which illustrates the steps of bubbling E1, filtering E2 and solidification E3 of a purification method.

### 4.1. Bubbling

After casting the liquid silicon into the casting ladle 4 of the purification device, a refining (bubbling step E1) by injection of air (or any other inert gas) into the silicon bath contained in the tank is carried out.

Refining removes common impurities—such as aluminum and calcium—contained in the liquid 2N purity silicon obtained from the production device. This air injection is carried out using the injection nozzle 42.

Under the effect of bubbling, common impurities form a slag containing alumina, lime and silica. This slag floats and is therefore easy to eliminate using any suitable technique known to the person skilled in the art, such as a suction, skimming or decantation technique.

Advantageously, the flow rate and speed of the air (or inert gas) introduced into the bath of liquid silicon are respectively comprised between 2 and 10 m³/h and 0.1 to 1 m/s to maximize the elimination of common impurities.

Moreover, the temperature of the silicon bath is maintained greater than or equal to 1600° C., and preferably greater than or equal to 1700° C. This allows to guarantee the effectiveness of the filtering carried out subsequently by limiting the risks of inappropriate solidification of silicon in the filter 44 contained in the tank 41. Such a solidification would in fact risk clogging the filter 44.

The bubbling step E1 allows to obtain a refined liquid silicon in which the concentration of common impurities is reduced.

### 4.2. Filtering

Under the effect of gravity, the refined liquid silicon moves towards the outlet channel 45 of the casting ladle 4.

The refined liquid silicon passes through the filter 44, the size of the pores of which prevents the passage of solid particles with dimensions greater than 75 um. These solid particles (unreacted raw materials, by-products generated during the carbon reduction reaction, etc.) constitute impurities.

The retention of these solid impurities by the filter 44 therefore allows to improve the purity of the filtered liquid silicon having passed through the filter.

At the end of the filtration step, the filtered liquid silicon flows into the electromagnetic stirrer through the outlet channel 45.

The reader will appreciate that the bubbling and filtration steps can be implemented simultaneously.

### 4.3. Solidification

The solidification step can then be initiated, preferably with strong stirring (speed of the liquid silicon bath >1 m/second). The presence of strong stirring eliminates the risk of segregation defects related to the accumulation of impurities at the solidification front.

The solidification step is carried out at a high speed, in particular greater than or equal to 5 cm/h, preferably greater than or equal to 10 cm/h. Indeed, rapid solidification allows:
on the one hand to minimize the costs related to the implementation of this solidification step (the faster the solidification, the more its cost is reduced), and
on the other hand to limit the generation of waste and the electrical energy consumed.

When the desired amount of silicon has solidified, the solidification step is interrupted: a purified solid silicon bell 514 and a liquid residue of impure silicon 515 are obtained.

This liquid residue of impure silicon 515 (that is to say liquid remaining at the end of the solidification step) is discharged by tilting the electromagnetic stirrer (rotation along the axis z) in an ingot mold.

The crucible is then turned over to unmold and remove the silicon bell.

### 5. Conclusions

The apparatus and method described above allow to obtain a bell of purified solid 3N or higher purity silicon.

In particular, the presence of a purification device allows to eliminate numerous impurities contained in the metallurgical grade silicon obtained using the production device illustrated in FIG. 2.

The reader will have understood that numerous modifications can be made to the invention described above without materially departing from the new teachings and advantages described here.

1. An apparatus for producing 3N or higher purity silicon, the apparatus comprising a device for producing 2N purity silicon including:
a sealed enclosureconnected to at least one suction pump to generate a depression inside the enclosure when the suction pump is activated,
an electric arc furnace housed inside the sealed enclosure, the arc furnace including a tank for containing a mixture of raw materials, and a set of electrodes configured to heat said mixture in order to produce 2N purity silicon,
a purification device for obtaining 3N purity silicon, said purification device including a casting ladle and an electromagnetic stirrer downstream of the casting ladle:
wherein the casting ladle includes including:
a reservoir adapted to contain a bath of silicon in the liquid state, said bath being composed of 2N purity silicon obtained from the production device,
an injection nozzle for injecting a gas into the silicon bath in the liquid state, the injection of the gas allowing to obtain a refined liquid silicon having a purity greater than the 2N purity silicon resulting from the production device,
a filter disposed upstream of the electromagnetic stirrerfor filtering the refined liquid silicon, the filtering allowing to obtain a filtered liquid silicon having a purity greater than the refined liquid silicon, and
wherein the electromagnetic stirrer being is configured to receive the liquid filtered silicon and to solidify it at a solidification speed greater than or equal to 5 cm/h, preferably greater than or equal to 10 cm/h, the solidification allowing to obtain a purified solid silicon bell forming the 3N or higher purity silicon.

2. The apparatus according to claim 1, wherein the electromagnetic stirrer comprises a mechanical mixer and/or an inductive stirrer to induce a movement of the liquid filtered silicon at a speed greater than or equal to 1 ms.

3. The apparatus according to claim 1, wherein the filter comprises pores whose dimensions are comprised between 75 micrometers and 3 millimeters, preferably between 100 micrometers and 2.5 millimeters, and even more preferably between 500 micrometers and 2 millimeters.

4. The apparatus according to claim 1, wherein the casting ladle further includes a heating system configured to maintain the silicon bath in the liquid state contained in the reservoir at a temperature greater than or equal to 1600° C., preferably greater than or equal to 1700° C.

5. The apparatus according to claim 1, wherein the nozzle is supplied with gas by a power source configured to inject said gas at a flow rate comprised between 2 and 10 m³/h.

6. The apparatus according to claim 1, wherein the electromagnetic stirrer is devoid of thermal insulator to induce cooling of the purified solid silicon block at a speed comprised between 150° C./h and 500° C./h, preferably between 200° C./h and 300° C./h.

7. The apparatus according to claim 1. wherein the device for producing 2N purity silicon further comprises a control unit configured to:
during a pretreatment step:
reduce the pressure inside the enclosed space to a value below atmospheric pressure,
implement resistive heating of the mixture of raw materials,
during a carbon reduction step:
increase the pressure inside the enclosed space to a value substantially equal to atmospheric pressure,
implement electric arc heating of the mixture of raw materials,
then when the temperature of the mixture is greater than 2000° C.:
maintain the pressure inside the enclosed space at a value substantially equal to atmospheric pressure,
maintain electric arc heating of the mixture of raw materials,
during a post-treatment step:
reduce the pressure inside the enclosed space to a value below atmospheric pressure.

8. A method for producing 3N or higher purity silicon, the method comprising:
a phase of producing 2N purity silicon from a production device including a sealed enclosure connected to a suction pump, and an electric arc furnace housed inside the sealed enclosure, the production phase including the following steps:
loading an electric arc furnace tank with a mixture of raw materials,
generating a depression inside the enclosure by activating the suction pump,
heating the mixture using a set of arc furnace electrodes (so as to produce 2N purity silicon,
a purification phase for obtaining 3N purity silicon from a purification device including a casting ladle and an electromagnetic stirrer downstream of the casting ladle, wherein said purification phase including includes the following steps:
of injecting, using an injection nozzle of the casting ladle, a gas into a silicon bath in the liquid state composed of 2N purity silicon obtained from the production device, said bath being contained in a reservoir of the casting ladle (4), the injection of the gas allowing to obtain a refined liquid silicon having a purity greater than the 2N purity silicon resulting from the production device,
filtering, using a filter disposed upstream of the electromagnetic stirrer, refined liquid silicon to obtain a filtered liquid silicon having a purity higher than the refined liquid silicon, and
solidifying, using the electromagnetic stirrer, the liquid filtered silicon at a solidification speed greater than or equal to 5 cm/h, preferably greater than or equal to 10 cm/h.

9. The method according to claim 8, wherein the solidification step comprises a sub-step consisting in stirring the liquid filtered silicon at a speed greater than or equal to 1 ms.

10. The method according to claim 8, wherein the filtering step consists in circulating the refined liquid silicon through a filter having pores whose dimensions are comprised between 75 micrometers and 3 millimeters, preferably between 100 micrometers and 2.5 millimeters, and even more preferably between 500 micrometers and 2 millimeters.

11. The method according to claim 8, wherein during the injection step, the gas is injected into the liquid silicon bath at a flow rate comprised between 2 and 10 m³/h.

12. The method according to claim 8, wherein the phase of producing 2N purity silicon comprises the following steps:
a pretreatment step including the sub-steps consisting in:
reducing the pressure inside the enclosure to a value lower than atmospheric pressure,
implementing resistive heating of the mixture of raw materials,
carbon reduction step including the sub-steps consisting in:
increasing the pressure inside the enclosed space to a value substantially equal to atmospheric pressure,
implementing electric arc heating of the mixture of raw materials,
then when the temperature of the mixture is greater than 1500° C.:
maintaining the pressure inside the enclosed space at a value substantially equal to atmospheric pressure,
maintaining electric arc heating of the mixture of raw materials,
a post-treatment step including a sub-step consisting in reducing the pressure inside the enclosed space.
